(19) United States
(12) Patent Application Publication
(10) Pub. No.: US 2007/0139402 A1
(43) Pub. Date: Jun. 21, 2007

(54) Image display control method

(75) Inventor: Chiao-Yung Chang, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Avermedia Technologies, Inc.

(21) Appl. No.: 11/339,778

(22) Filed: Jan. 25, 2006

(30) Foreign Application Priority Data
Dec. 21, 2005 (TW) 094145654

(51) Int. Cl. H04N 5/45; H04N 5/445; G09G 5/00

(52) U.S. Cl. 345/204; 348/564; 348/565

(57) ABSTRACT

In an image display control method for use with a computer system, a main frame and a sub-frame are simultaneously shown on the display. Then, a function menu bar is displayed at an edge of the sub-frame in response to a specific action of a cursor control device of the computer system, wherein the function menu bar has a smaller area than the sub-frame. Afterwards, in response to a clicking action on a first icon of the function menu bar, the relative positions of the main frame and the sub-frame are changed.

### FIELD OF THE INVENTION

The present invention relates to an image display control method, and more particularly to an image display control method used with a computer system.

### BACKGROUND OF THE INVENTION

Nowadays, many electrical appliances are widely used with computers due to the amazing power of computers. For example, referring to FIG. 1, the TV signals issued from a TV set can be transmitted to a host computer 11 via a TV box 10 so as to be displayed on a computer display 12.

For a purpose of allowing two sources to be simultaneously viewed, by execution of a display control application program, which has been installed in the host computer 11, a main frame 121 and a sub-frame 120 are displayed on the display 12, as is shown in FIG. 2. Usually, the sub-frame 120 is arranged on a predetermined corner (for example the upper left corner) of the main frame 121. When the operator intends to change the position of the sub-frame 120, a comprehensible function menu 122 of several selective items is shown on the display 12 in response to an actuating action of the cursor control device (e.g. a mouse) or a keyboard. Via the function menu 122, the user may control movement of the sub-frame 120 to a desired position. Since the appearance of the function menu 122 shields a large portion of the main frame 121, the function menu 122 becomes hindrance from viewing the main frame 121. In addition, due to slow position change of the sub-frame 120, some desirable images are subjected to loss.

### SUMMARY OF THE INVENTION

The present invention provides an image display control method for controlling the relative positions of the main frame and the sub-frame without shielding most portion of the main frame.

In accordance with an aspect of the present invention, there is provided an image display control method for use with a computer system. Firstly, a main frame and a sub-frame are simultaneously shown on the display. Then, by operating the cursor control device in a specific manner, a function menu bar is displayed next to the sub-frame, wherein the function menu bar has a smaller area than the sub-frame. Afterwards, by enabling a first icon of the function menu bar, the relative positions of the main frame and the sub-frame are changed.

In an embodiment, the function menu bar is moved with the sub-frame when the relative positions of the main frame and the sub-frame are changed.

In an embodiment, by clicking a specified button of the cursor control device, the first icon of the function menu bar is enabled.

In an embodiment, the specific manner is to click a button of the cursor control device.

In an embodiment, the specific manner is to manipulate the cursor control device to move a cursor into a region of the sub-frame.

In an embodiment, the sub-frame is moved to an upper left corner, an upper right corner, a lower left corner or a lower right corner of the main frame when the first icon of the function menu bar is enabled.

In an embodiment, the image display control method further comprises a step of switching the main frame and the sub-frame when a second icon of the function menu bar is enabled.

In an embodiment, the image display control method further comprises a step of switching an arrangement of the main frame and the sub-frame from a PIP (picture-in-picture) mode to a POP (picture-on-picture) mode when a third icon of the function menu bar is enabled.

In an embodiment, the image display control method further comprises a step of locking the arrangement of the main frame and the sub-frame in the POP mode when a fourth icon of the function menu bar is enabled.

In an embodiment, the cursor control device is a mouse. Alternatively, the cursor control device is a trackball.

In an embodiment, the main frame and the sub-frame are simultaneously shown on the display by executing an application program.

In an embodiment, the main frame and the sub-frame are generated by a TV box of the computer system.

In an embodiment, the main frame and the sub-frame are generated by a video adapter of the computer system.

In accordance with an aspect of the present invention, there is provided an image display control interface of a computer system for adjusting a main frame and a sub-frame simultaneously shown on a display of the computer system. The image display control interface comprises a control device and a function menu bar. The function menu bar is shown on the display at a position next to the sub-frame when the control device is activated for the sub-frame and comprises a plurality of icons to be selectively enabled by manipulating the control device. By enabling different icons of the function menu bar, different arrangements of the main frame and the sub-frame are rendered. The function menu bar stays next to the sub-frame when the arrangement of the sub-frame is changed.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic circuit block diagram illustrating a computer system having the function of viewing the TV program;

FIG. 2 is a schematic view showing a main frame and a sub-frame simultaneously shown on the display according to prior art;

FIG. 3 is a flowchart illustrating an image display control method according to a preferred embodiment of the present invention;

FIG. 4 is a schematic view showing a main frame and a sub-frame simultaneously shown on the display according to the present invention;

FIGS. 5(a)˜5(g) are schematic views illustrating relative locations of the main frame and the sub-frame, which are adjusted according to the image display control method of the present invention; and

FIG. 6 is a schematic view illustrating the icons of the function menu bar.

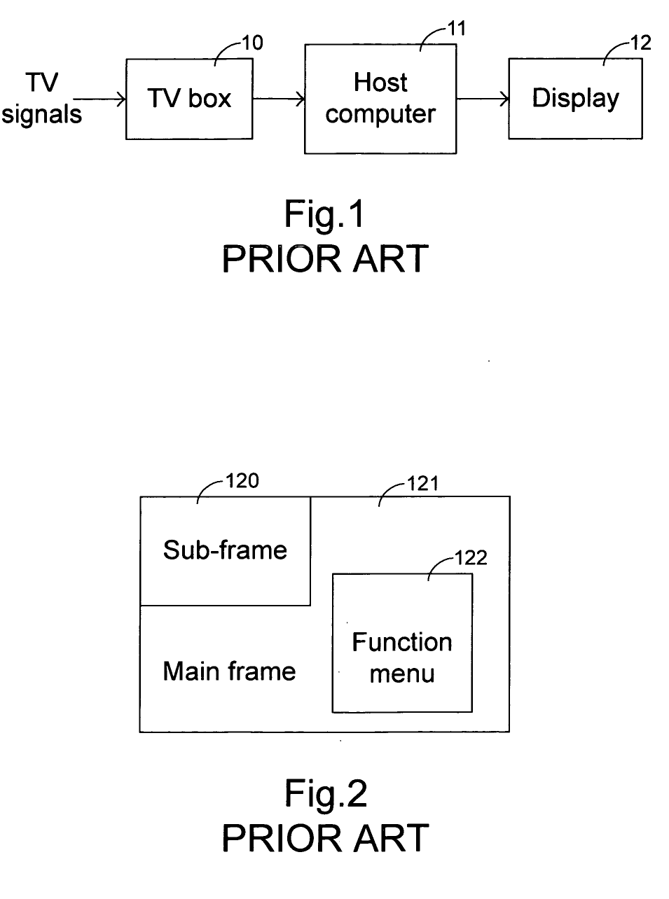

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

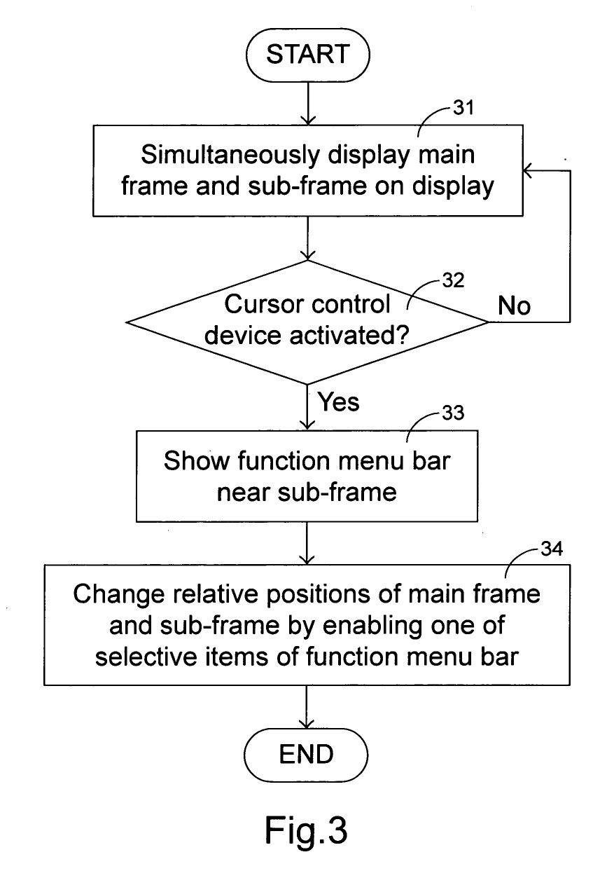

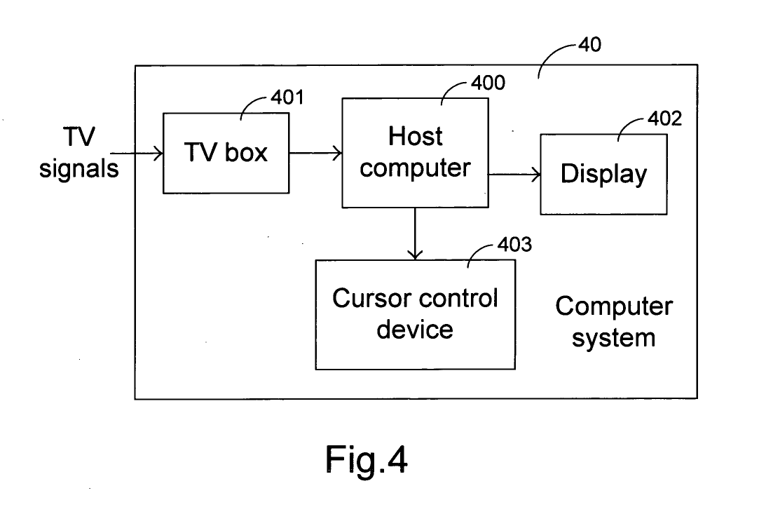

Hereinafter, an embodiment of an image display control method for use with a computer system according to the present invention will be illustrated with reference to FIGS. 3, 4 and 5.

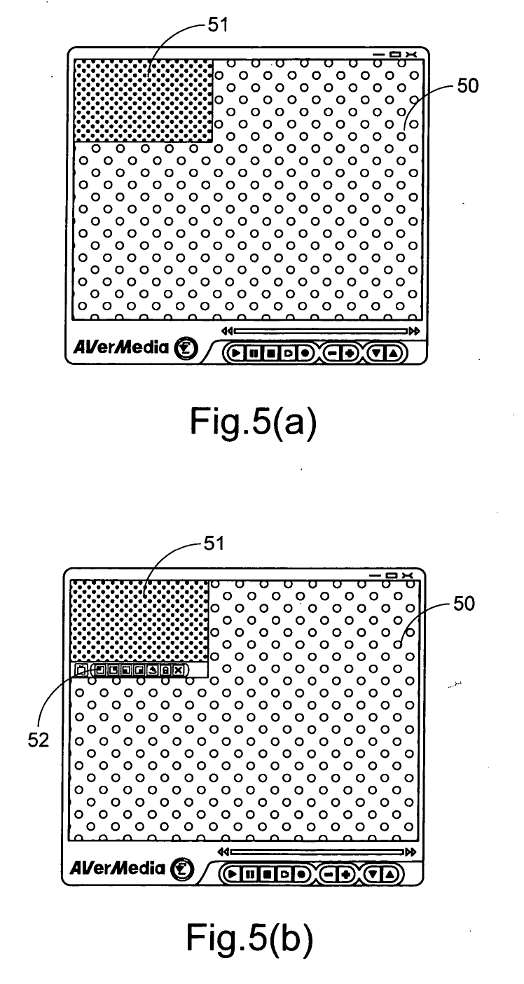

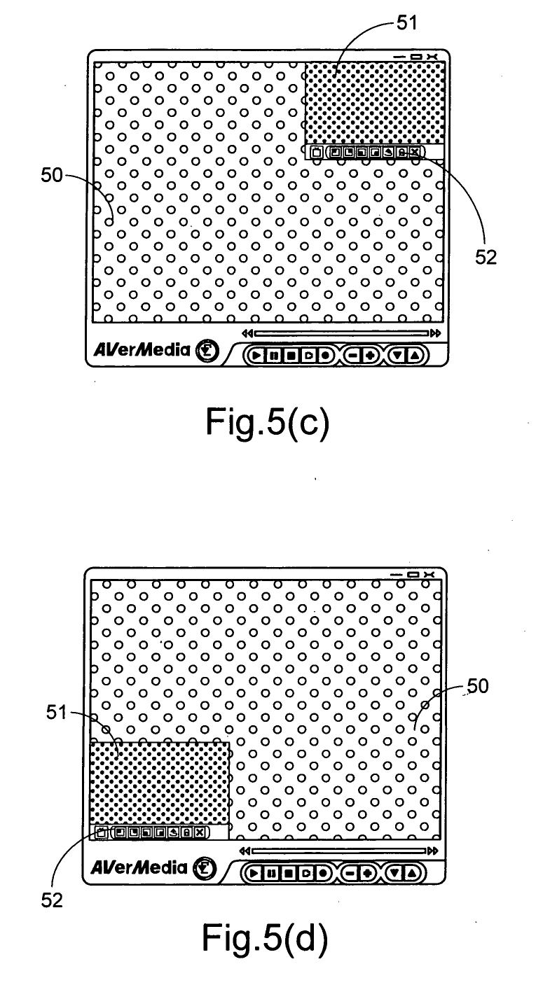

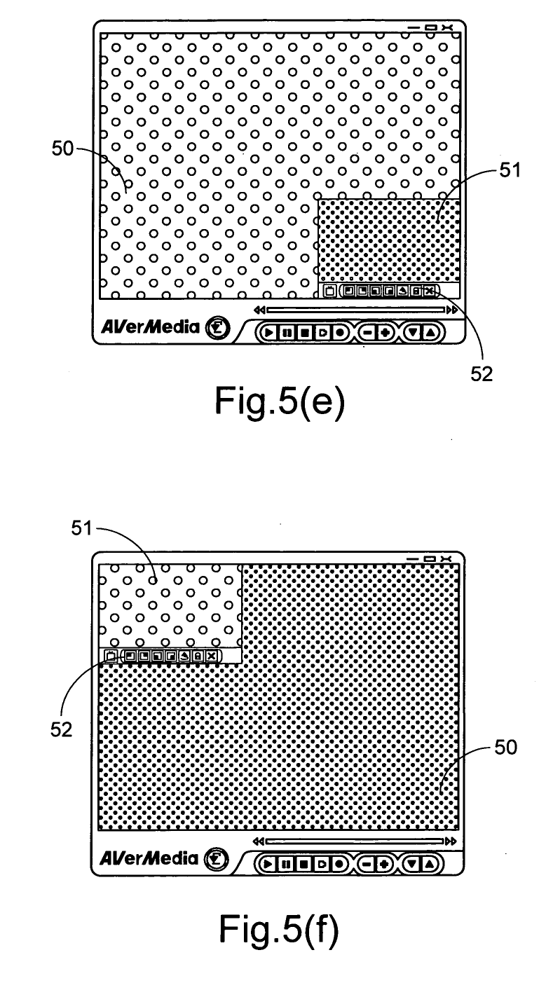

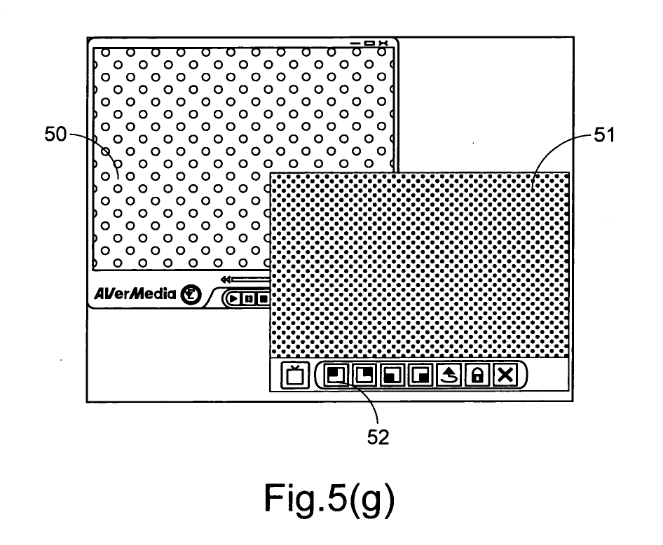

The image display control method is used with a computer system 40 that comprises a host computer 400, a TV box 401, a display 402 and a cursor control device 403. The TV signals issued from a TV set can be transmitted to the host computer 400 via the TV box 401. The TV signals are processed by the host computer 400, and then shown on the display 402. First of all, with execution of an application program installed in the host computer 400, the main frame 50 and the sub-frame 51 are simultaneously shown on the display 402 (Step 31 in FIG. 3 and FIG. 5(a)). If a button of the cursor control device 403 is pressed down or the cursor is located within the sub-frame 51 (Step 32), a function menu bar 52 whose area is smaller than the sub-frame 51 is shown next to the sub-frame 51 (Step 33 in FIG. 3 and FIG. 5(b)). The function menu bar 52 next to the sub-frame 51 does not mean the function menu bar 52 has to be exactly contiguous to the sub-frame 51. However, the function menu bar 52 is preferably as close to the sub-frame 51 as possible and movable with the sub-frame 51. It is also feasible to have the function menu bar 52 extend from an edge of the sub-frame 51, keep a clearance from an edge of the sub-frame 51 or partially overlap an edge of the sub-frame 51. Aside from, the function menu “bar” 52 can be any suitable shape instead of exactly bar-shaped. For example, it can be an L-shaped “bar” arranged at a corner of the sub-frame 51. Meanwhile, when one of the selective items shown in the icon of the function menu bar 52 is clicked, the position of the sub-frame 51 relative to the main frame 50 is changed as desired (Step 34 in FIG. 3 and FIG. 5(c), 5(d), 5(e) or 5(f)).

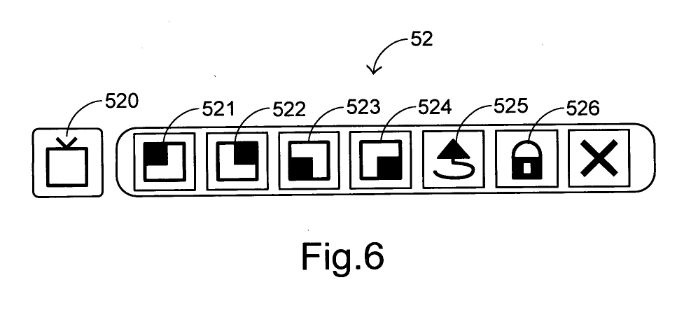

Referring to FIG. 6, an enlarged view of the function menu bar is illustrated. The function menu bar 52 comprises several icons 520, 521, 522, 523, 524, 525 and 526. In response to the clicking actions on the highlight icons of the function menu bar 52, the relative positions of the sub-frame 51 will be changed. As shown in FIG. 5(b), the function menu bar 52 is shown at the lower edge of the sub-frame 51, which is located at the upper left corner of the main frame 50. When the icon 520 is clicked, the contents of the main frame 50 and the sub-frame 51 are exchanged with each other. That is, the images shown in FIG. 5(b) will be switched to those shown in FIG. 5(f) in response to the clicking action on the icon 520 of the function menu bar 52. When the icons 521, 522, 523 and 524 are clicked, the sub-frame 51 will be moved to the upper left corner, the upper right corner, the lower left corner and the lower right corner of the main frame 50.

As shown in FIGS. 5(b)˜5(f), in addition to a program being watched, the PIP (picture-in-picture) mode allows a second program to be displayed at the corner of the screen. When the icon 525 is clicked, the images shown in FIGS. 5(b)˜5(f) will be switched to a POP (picture-on-picture) mode as shown in FIG. 5(g). In this POP mode, a portion of the sub-frame 51 is superposed on the main frame 50. Under this circumstance, the sub-frame 51 can be moved to any position and the size thereof can be adjusted as required.

If the icon 526 is clicked, the relative positions of the main frame 50 and the sub-frame 51 in the POP mode as shown in FIG. 5(g) are locked. Meanwhile, the sub-frame 51 is synchronously moved with the movement of the main frame 50.

In the above embodiments, the cursor control device 403 used with the present invention is a mouse or a trackball. The TV box 401 can be replaced by a video expansion card such as a PCI-interface video adapter mounted on a motherboard of a personal computer or a PCMICIA-, Cardbus- or PCI Express Card-interface video adapter.

From the above description, by providing the function menu bar at an edge of the sub-frame, the image display control method of the present invention is capable of controlling the relative positions of the main frame and the sub-frame. Since the area of the function menu bar is smaller than the sub-frame, the appearance of the function menu bar will no longer become hindrance from viewing the main frame.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image display control method for use with a computer system, the computer system comprising a display and a cursor control device, the image display control method comprising steps of:
simultaneously showing a main frame and a sub-frame on the display;
displaying a function menu bar next to the sub-frame by operating the cursor control device in a specific manner, wherein said function menu bar has a smaller area than the sub-frame; and
changing the relative positions of the main frame and the sub-frame by enabling a first icon of said function menu bar.

2. The image display control method according to claim 1 wherein said function menu bar is moved with the sub-frame when the relative positions of the main frame and the sub-frame are changed.

3. The image display control method according to claim 1 wherein said first icon of said function menu bar is enabled by clicking a specified button of the cursor control device.

4. The image display control method according to claim 1 wherein said specific manner is to click a button of the cursor control device.

5. The image display control method according to claim 1 wherein said specific manner is to manipulate the cursor control device to move a cursor into a region of the sub-frame.

6. The image display control method according to claim 1 wherein the sub-frame is moved to an upper left corner, an upper right corner, a lower left corner or a lower right corner of the main frame when said first icon of the function menu bar is enabled.

7. The image display control method according to claim 1 further comprising a step of switching the main frame and the sub-frame when a second icon of the function menu bar is enabled.

8. The image display control method according to claim 1 further comprising a step of switching an arrangement of the main frame and the sub-frame from a PIP (picture-in-picture) mode to a POP (picture-on-picture) mode when a third icon of the function menu bar is enabled.

9. The image display control method according to claim 8 further comprising a step of locking said arrangement of the main frame and the sub-frame in said POP mode when a fourth icon of the function menu bar is enabled.

10. The image display control method according to claim 1 wherein the cursor control device is a mouse.

11. The image display control method according to claim 1 wherein the cursor control device is a trackball.

12. The image display control method according to claim 1 wherein the main frame and the sub-frame are simultaneously shown on the display by executing an application program.

13. The image display control method according to claim 1 wherein the main frame and the sub-frame are generated by a TV box of the computer system.

14. The image display control method according to claim 1 wherein the main frame and the sub-frame are generated by a video adapter of the computer system.

15. An image display control interface of a computer system for adjusting a main frame and a sub-frame simultaneously shown on a display of the computer system, comprising:
a control device; and
a function menu bar shown on the display at a position next to the sub-frame when said control device is activated for the sub-frame and comprising a-plurality of icons to be selectively enabled by manipulating said control device,
wherein different arrangements of the main frame and the sub-frame are rendered by enabling different icons of said function menu bar, and said function menu bar stays next to the sub-frame when the arrangement of the sub-frame is changed.

16. The image display control interface according to claim 15 wherein the relative positions of the main frame and the sub-frame are changed by enabling a first one of said icons.

17. The image display control interface according to claim 15 wherein the main frame and the sub-frame are switched by enabling a second one of said icons.

18. The image display control interface according to claim 15 wherein the arrangements of the main frame and the sub-frame are changed from PIP (picture-in-picture) mode to a POP (picture-on-picture) mode by enabling a third one of said icons.

19. The image display control interface according to claim 15 wherein said control device is a cursor control device optionally manipulated to have a cursor shown and moved on the display.

20. The image display control interface according to claim 19 wherein said cursor control device is activated for the sub-frame by triggering a button of said cursor control device or moving said cursor into a region of the sub-frame.
